(19) United States
(12) Patent Application Publication
(10) Pub. No.: US 2025/0156796 A1
(43) Pub. Date: May 15, 2025

(54) DELIVERY ASSISTANCE SYSTEM, DELIVERY ASSISTANCE METHOD, AND RECORDING MEDIUM

(71) Applicant: NEC Corporation, Minato-ku, Tokyo (JP)

(72) Inventors: Kaori Yamane, Tokyo (JP); Yosuke Umeda, Tokyo (JP); Yuma Kamimoto, Tokyo (JP)

(73) Assignee: NEC Corporation, Minato-ku, Tokyo (JP)

(21) Appl. No.: 18/833,048

(22) PCT Filed: Mar. 11, 2022
(86) PCT No.: PCT/JP2022/011020

§ 371 Date: Jul. 25, 2024

(51) Int. Cl. G06Q 10/083

(52) U.S. Cl. CPC G06Q 10/083

(57) ABSTRACT

A delivery assistance system comprising: at least one memory storing instructions; and at least one processor configured to execute the instructions to: acquire a shape and a weight of each of a plurality of packages; determine a storage box having a predetermined size and storing packages based on shapes and weights of the packages with a same destination among the plurality of packages; and output an instruction to store the packages in the determined storage box.

### TECHNICAL FIELD

The present disclosure relates to a delivery assistance system and the like.

### BACKGROUND ART

There is a case where a distribution company delivers packages of a plurality of consignors together. For example, there are packages with different attributes for each consignor, and delivery is performed jointly with a business operator with matching conditions such as a destination.

PTL 1 describes a technique of selecting a storage device capable of grouping a plurality of packages to be transported by a pickup base and ending all packages in the same group.

### CITATION LIST

### Patent Literature

PTL 1: JP 2021-082047 A

### SUMMARY OF INVENTION

### Technical Problem

For example, in a case where packages having the same destination are delivered together, if there are packages having different attributes, the weights and shapes of the packages vary. Therefore, in a case where there are a plurality of packages, the efficiency of loading the packages may be poor.

An object of the present disclosure is to provide a delivery assistance system or the like that more efficiently loads packages.

### Solution to Problem

A delivery assistance system according to an aspect of the present disclosure includes an acquisition means for acquiring a shape and a weight of each of a plurality of packages, a storage box determination means for determining a storage box having a predetermined size and storing packages based on shapes and weights of the packages with a same destination among the plurality of packages, and an output control means for outputting an instruction to store the packages in the determined storage box.

A delivery assistance method according to an aspect of the present disclosure includes acquiring a shape and a weight of each of a plurality of packages, determining a storage box having a predetermined size and storing the package based on shapes and weights of packages with a same destination among the plurality of packages, and outputting an instruction to store the package in the determined storage box.

A program according to one aspect of the present disclosure causes a computer to execute acquiring a shape and a weight of each of a plurality of packages, determining a storage box having a predetermined size and storing the package based on shapes and weights of packages with a same destination among the plurality of packages, and outputting an instruction to store the package in the determined storage box.

The program may be stored in a non-transitory computer-readable recording medium.

### Advantageous Effects of Invention

According to the present disclosure, it is possible to load packages more efficiently.

### BRIEF DESCRIPTION OF DRAWINGS

FIG. 1 is a block diagram illustrating a configuration example of a delivery assistance system according to a first example embodiment.

FIG. 2 is a flowchart illustrating an operation example of the delivery assistance system according to the first example embodiment.

FIG. 3 is an explanatory diagram illustrating an example in which packages of the same destination are packed in a storage box.

FIG. 4 is an explanatory diagram illustrating a series of flows of an example in which packages of the same destination are packed in a storage box.

FIG. 5 is an explanatory diagram illustrating an example of connection between the delivery assistance system according to a second example embodiment and another device.

FIG. 6 is a block diagram illustrating a configuration example of the delivery assistance system according to the second example embodiment.

FIG. 7 is an explanatory diagram illustrating an example in which the storable weight can be identified for each color.

FIG. 8 is an explanatory diagram illustrating an example in which a total weight of packages is 10 kg.

FIG. 9 is an explanatory diagram illustrating an example in which a total weight of packages is 30 kg.

FIG. 10 is an explanatory diagram illustrating an example in which a total volume of packages is 320,000 cm³.

FIG. 11 is an explanatory diagram illustrating an example in which a total volume of packages is 240,000 cm³.

FIG. 12 is an explanatory diagram illustrating an example of a screen to be displayed on a display device.

FIG. 13 is a flowchart illustrating an operation example of the delivery assistance system according to the second example embodiment.

FIG. 14 is an explanatory diagram illustrating a hardware configuration example of a computer.

### EXAMPLE EMBODIMENT

Hereinafter, example embodiments of a delivery assistance system, a delivery assistance method, a program, and a non-transitory recording medium recording the program according to the present disclosure will be described in detail with reference to the drawings. The present example embodiment does not limit the disclosed technology.

### First Example Embodiment

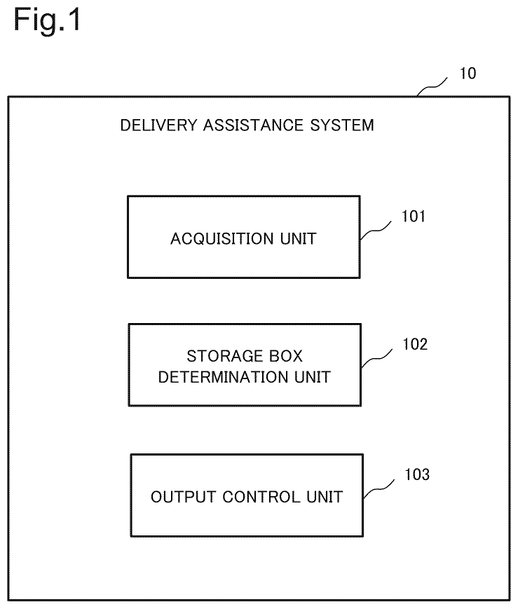

First, in a first example embodiment, a basic function of a delivery assistance system will be described. FIG. 1 is a block diagram illustrating a configuration example of the delivery assistance system according to the first example embodiment. A delivery assistance system 10 is provided with an acquisition unit 101, a storage box determination unit 102, and an output control unit 103.

The acquisition unit 101 acquires the shape and weight of each of a plurality of packages. Here, for example, the plurality of packages may be sorted in advance for each destination.

For example, regarding the shape of the package, the acquisition unit 101 acquires the shape of a specified package from the image captured by the imaging device. The shape may be, for example, a size such as a length, a width, and a height of the package, a volume of the package, a predetermined classification, or the like, or is not particularly limited as long as the shape is information that can be specified. Examples of the classification include a rectangular box shape, a square box shape, a rod shape, and the like. The classification may include the type of package. For example, the classification includes raw objects, fragile objects, and the like.

For example, regarding the weight of the package, the acquisition unit 101 acquires the weight of the package measured by a weight sensor.

Next, the storage box determination unit 102 determines a storage box for packages with the same destination among the plurality of packages based on the shapes and weights of packages with the same destination. The storage box is determined in advance. The destination here is not limited to a specific destination, and may be a destination direction or the like. The destination here is not limited to the final destination, and may be a waypoint on the way.

Here, the number of storage boxes determined by the storage box determination unit 102 is not limited. Specifically, for example, the storage box determination unit 102 may determine the storage box so that the number of storage boxes is the smallest based on the shapes and weights of packages with the same destination among the plurality of packages. Alternatively, for example, the storage box determination unit 102 may determine the storage box so that the weights of the packages stored in the storage boxes are equal based on the shapes and weights of packages with the same destination among the plurality of packages. More specifically, for example, the storage box and the package to be put in the storage box may be determined such that a difference in weight of the package stored in each storage box falls within a predetermined range.

The method of determining various storage boxes by the storage box determination unit 102 is not particularly limited as long as an existing technology is used.

The output control unit 103 outputs an instruction for storing the packages with the same destination in the determined storage box. For example, the output control unit 103 may output an instruction through the output device so that the operator can confirm the instruction. Examples of the output device include, but are not particularly limited to, a display device, a sound output device, and the like.

In the case of being stored in a robot or the like, the output control unit 103 may control the robot based on an instruction. In the case of controlling the robot, for example, the output control unit 103 generates a command according to an instruction and transmits the generated command to the robot. Alternatively, the output control unit 103 may notify the robot of the instruction.

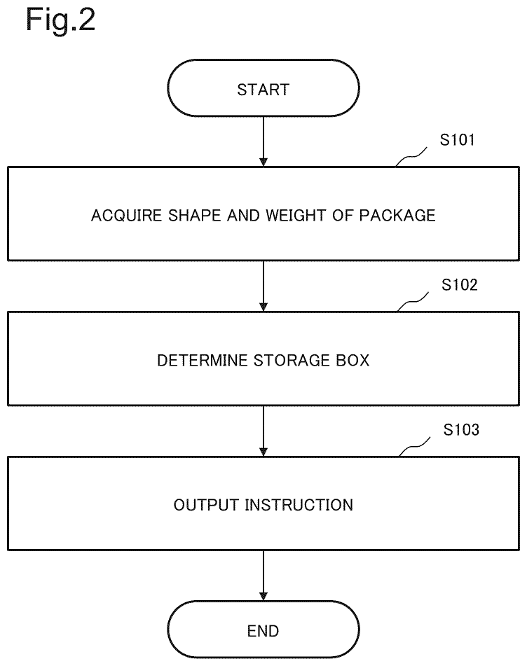

FIG. 2 is a flowchart illustrating an operation example of the delivery assistance system 10 according to the first example embodiment. The acquisition unit 101 acquires the shape and weight of each of the plurality of packages (step S101).

Next, the storage box determination unit 102 determines a storage box in which the packages of the same destination are stored based on the shapes and weights of packages with the same destination (step S102). Then, the output control unit 103 outputs an instruction to store the package in the determined storage box (step S103). The delivery assistance system 10 ends the process.

As described above, in the first example embodiment, the delivery assistance system 10 determines the storage box that stores the packages of the same destination based on the shapes and weights of packages with the same destination, and outputs an instruction to store the package in the determined storage box. Since the storage box is determined in advance, the packing form of package at the time of delivery is standardized by putting each package in the storage box. Therefore, it is possible to more efficiently mount the package on the means for delivering the package. For example, even in the case of transshipment or the like, if the packing form of the package at the time of delivery is standardized, the package can be more efficiently loaded. For example, since the packing form is standardized, it is possible to facilitate loading and unloading in the case of jointly delivering packages. Furthermore, since the packing form is standardized, it is possible to improve a matching rate in a case where packages are delivered together. As a result, it is possible to improve the loading rate of the means for delivering packages. Means for delivering the package stored in the storage box is not particularly limited, and examples thereof include a vehicle, a drone, a ship, and an airplane. The vehicle is not particularly limited, and examples thereof include a truck and a bicycle.

### Second Example Embodiment

Hereinafter, a second example embodiment will be described in detail with reference to the drawings. In the second example embodiment, a method of determining a storage box will be described in more detail. Hereinafter, description of contents overlapping with the above description will be omitted to the extent that the description of the present second example embodiment is not unclear.

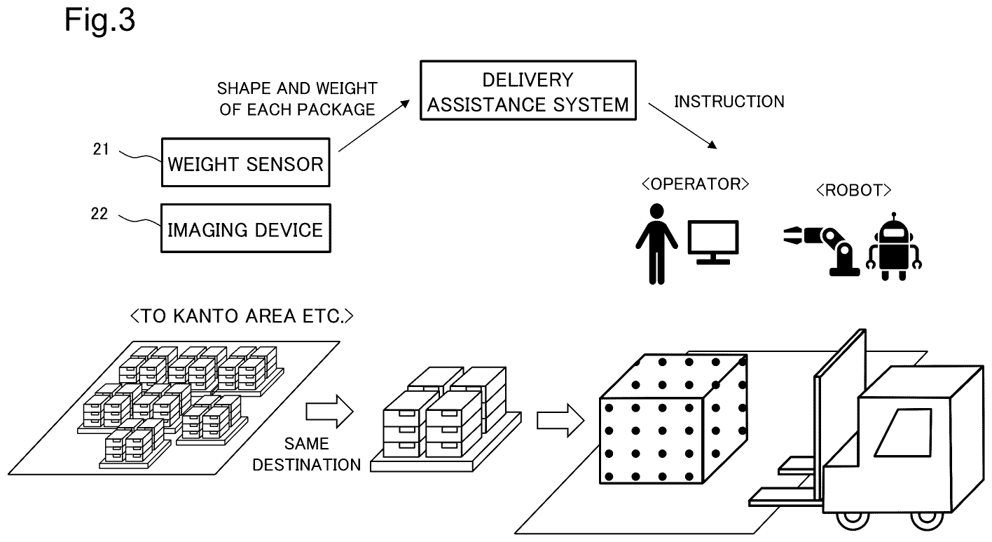

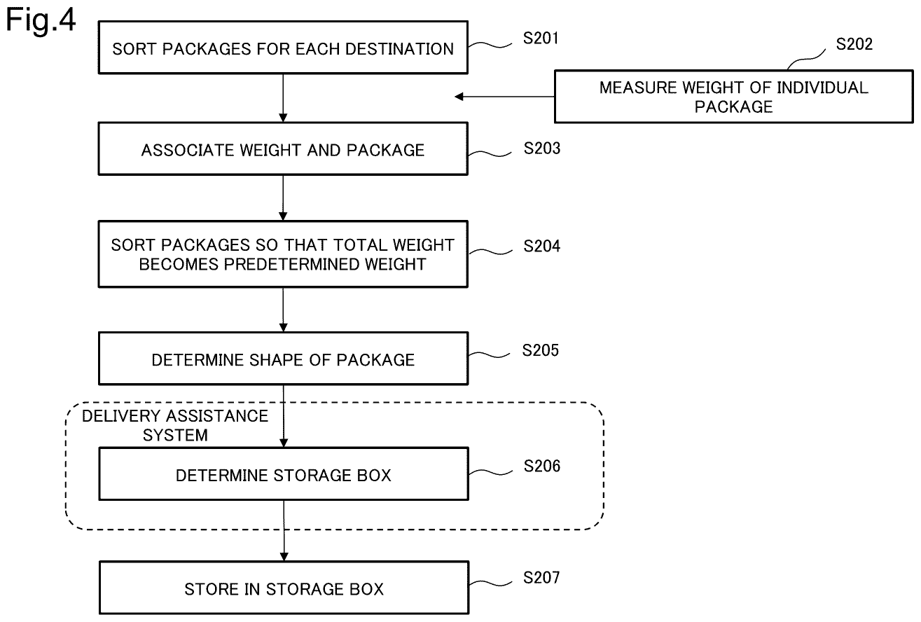

FIG. 3 is an explanatory diagram illustrating an example in which packages of the same destination are packed in a storage box. FIG. 4 is an explanatory diagram illustrating a series of flows of an example in which packages of the same destination are packed in a storage box.

In FIG. 3, for example, an operator or a transport robot sorts the packages for each destination (step S201). As described above, the destination here is not limited to a specific destination, and may be a destination direction or the like. The destination here is not limited to the final destination, and may be a waypoint on the way.

A weight sensor 21 measures the weight of each package (step S202). The weight sensor 21 associates the weight with the package (step S203). Here, associating means that the weight sensor 21 registers the identification information of the package and the weight in a database or the like in association with each other.

The operator or the transport robot may sort the packages so that the total weight becomes a predetermined weight for each destination (step S204). The predetermined weight here may be plural. The predetermined weight may be, for example, a maximum weight that can be stored in the storage box, or may be a weight that allows an operator or a transport robot to easily do work, and is not particularly limited.

An imaging device 22 images each package and determines the shape of the package based on the captured image (step S205).

A delivery assistance system 20 determines a storage box based on a predetermined weight and the shape of each package (step S206). As illustrated in FIG. 4, for example, the delivery assistance system 20 notifies the operator or the transport robot of an instruction to store the package in the determined storage box.

Then, the operator or the transport robot stores the package in the determined storage box (step S207).

An example has been described in which the weight sensor 21 performs the associating of the weight with the package in step S203. For example, the delivery assistance system 20 may have a function of associating a weight measured by the weight sensor 21 with a package. The delivery assistance system 20 may have a function of specifying the shape of the package from the image of the package.

Next, details of the delivery assistance system 20 that determines the storage box will be described.

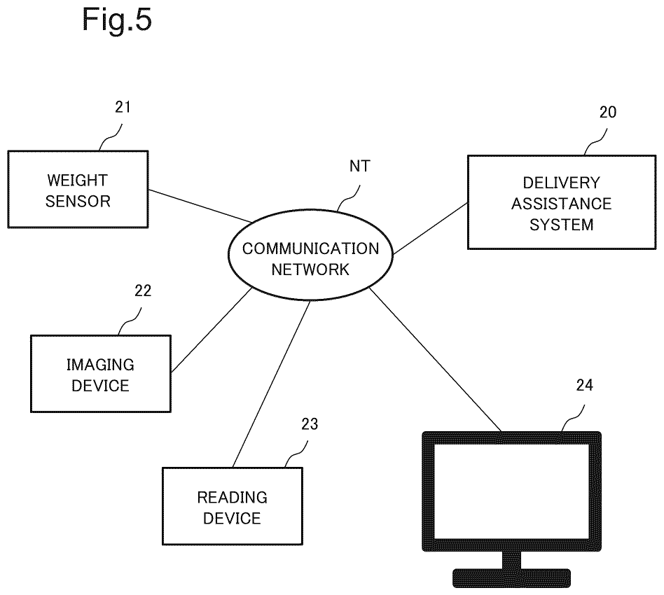

FIG. 5 is an explanatory diagram illustrating an example of connection between the delivery assistance system 20 according to the second example embodiment and another device. For example, the delivery assistance system 20 is connected to the weight sensor 21, the imaging device 22, a reading device 23, a display device 24, and the like via a communication network. In FIG. 5, one communication network NT is exemplified for ease of description, but the delivery assistance system 20 may be connected by different communication networks NT for the devices, and is not particularly limited.

The weight sensor 21 measures, for example, the weight of each package. For example, the imaging device 22 images each package. Then, the imaging device 22 specifies the shape of the package from the captured image.

The reading device 23 is a device that reads a code in a case where a code such as a one-dimensional code or a two-dimensional code is attached to the storage box.

The display device 24 displays an instruction to store the package in the storage box. For example, the display device 24 may display an instruction under the control of the delivery assistance system 20.

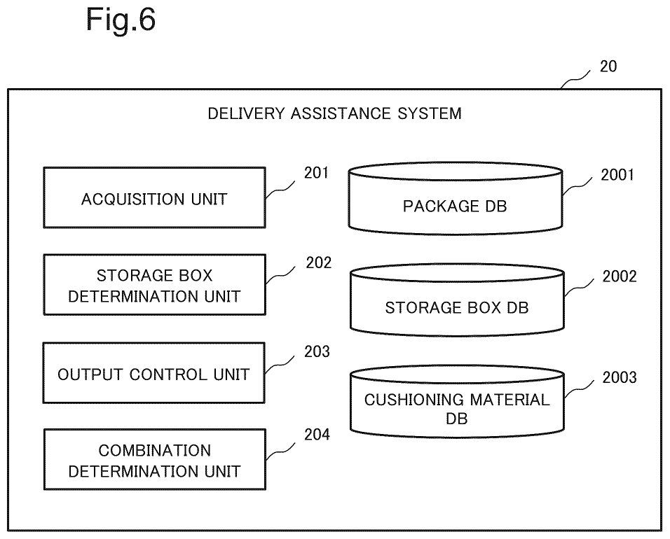

FIG. 6 is a block diagram illustrating a configuration example of the delivery assistance system 20 according to the second example embodiment. This delivery assistance system 20 is provided with an acquisition unit 201, a storage box determination unit 202, an output control unit 203, and a combination determination unit 204. In the delivery assistance system 20, the combination determination unit 204 is added to the delivery assistance system 10 according to the first example embodiment. The acquisition unit 201 has the function of the acquisition unit 101 according to the first example embodiment as a basic function. The storage box determination unit 202 has the function of the storage box determination unit 102 according to the first example embodiment as a basic function. The output control unit 203 has the function of the output control unit 103 according to the first example embodiment as a basic function.

The delivery assistance system 20 includes a package DB 2001, a storage box DB 2002, and a cushioning material DB 2003.

The package DB 2001 stores, for each package, a destination of the package, a weight of the package, and a shape of the package. The shape of the package is as described in the first example embodiment, and examples thereof include height, width, height, volume, classification, and the like. Specifically, for example, the package DB 2001 stores, for each package, the package identification information, the destination of the package, the weight of the package, and the shape of the package in association with each other. The package identification information is not particularly limited as long as it is information that can uniquely identify a package, such as a package number.

The storage box DB 2002 stores, for example, a storable weight and a storable size for each storage box. Specifically, for example, the storage box DB 2002 stores storage box identification information for identifying the storage box, a storable weight, and a storable size in association with each other. As the storable size, a length, a width, a height, a volume, and the like are defined. The storable weight may be in a range of storable weights.

The cushioning material DB 2003 stores, for example, the weight per predetermined unit of the cushioning material for each type of cushioning material. For example, the weight per predetermined unit is not particularly limited, and may vary depending on the type of the cushioning material, such as the weight per predetermined volume, the weight per predetermined area, and the weight per predetermined length.

The acquisition unit 201 acquires the shape and weight of each of the plurality of packages. Here, as described with reference to FIG. 3, for example, the plurality of packages may be sorted in advance for each destination. For example, regarding the shape of the package, the acquisition unit 201 acquires the shape of the specified package from the image captured by the imaging device 22. For example, regarding the weight of the package, the acquisition unit 201 acquires the weight of the package measured by the weight sensor 21. More specifically, for example, the acquisition unit 201 may acquire the shape and weight of the package from the package DB 2001.

Next, the storage box determination unit 202 determines a storage box for packages with the same destination among the plurality of packages based on the shapes and weights of packages with the same destination. As described in FIG. 3, the packages of the same destination may be sorted by predetermined weight in advance. Therefore, the storage box determination unit 202 may determine the storage box of the sorted package based on the shape and weight of the sorted package.

Here, the plurality of storage boxes have different sizes. As described above, for example, the sizes of the storage boxes are registered in the storage box DB 2002. Specifically, for example, the storage box determination unit 202 determines a storage box in which the package is stored from the plurality of storage boxes based on the shape of the package.

The plurality of storage boxes have predetermined storable weights. As described above, for example, the weights of the storage boxes are registered in the storage box DB 2002. Here, the plurality of storage boxes have appearances capable of identifying the storable weights. The appearance is at least one of a color, a pattern, a mark, and a code relevant to a storable weight. Specifically, for example, the storage box determination unit 202 determines a storage box capable of storing the package from the plurality of storage boxes based on the weight of the package.

Here, for example, an example in which storable weights of the plurality of storage boxes are different for each color will be described.

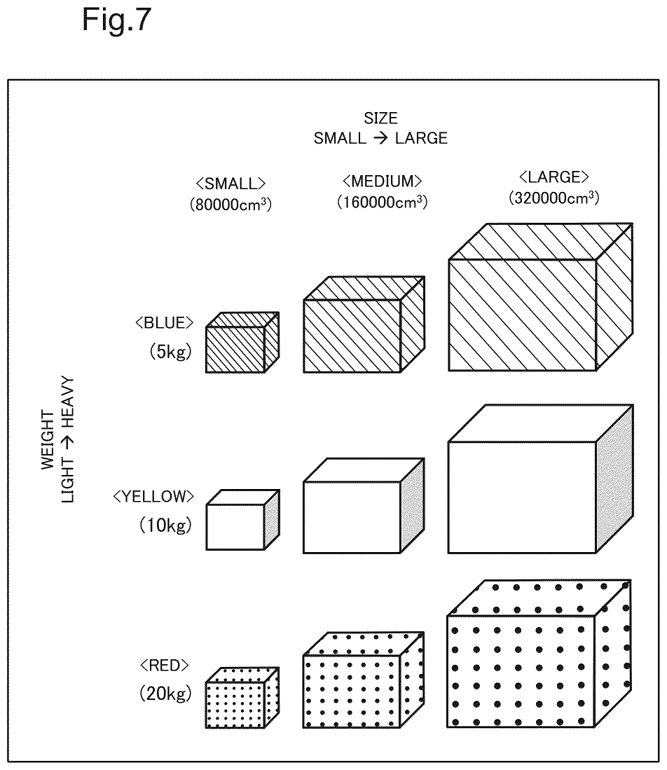

FIG. 7 is an explanatory diagram illustrating an example in which the storable weight can be identified for each color. The blue storage box may store up to 5 kg (kilograms), the yellow storage box may store up to 10 kg, and the red storage box may store up to 20 kg.

The storable weight may be in the range of the storable weights. For example, 1 kg or less may be classified as blue, a weight from more than 1 kg to 5 kg or less may be classified as yellow, and a weight from more than 5 kg to 10 kg or less may be classified as red.

Here, for easy understanding, in FIG. 7, the blue storage box is indicated by a stripe pattern, the yellow storage box is indicated by a plain pattern, and the red storage box is indicated by a dot pattern.

In FIG. 7, the storage boxes of the colors include storage boxes of different sizes such as large, medium, and small. For ease of description, it is assumed that the storage boxes of the colors have the same large, medium, and small sizes, but the sizes of the storage boxes may be different for each weight.

Here, in FIG. 7, a case where the volume of the small storage box is 80,000 cm³, the volume of the medium storage box is 160,000 cm³, and the volume of the large storage box is 320,000 cm³ will be described as an example.

As described in the first example embodiment, for example, the storage box determination unit 202 may determine the storage box so that the number of storage boxes is the smallest based on the shape and weight of the sorted package. As a result, the number of storage boxes can be reduced.

Alternatively, for example, the storage box determination unit 202 may determine the storage boxes so that the weights of the packages stored in the storage boxes are equal based on the shapes and weights of the sorted packages. As a result, since the weight of the storage box is uniform, the efficiency of the loading operation and the transshipment operation can be improved.

Alternatively, for example, the storage box determination unit 202 may determine the storage box so that the number of storage boxes having the same weight and size increases based on the shape and weight of the sorted package. This makes it possible to standardize the packing form of package at the time of delivery.

Here, in FIG. 7, the storage box determination unit 202 may determine the storage box based on the shape after determining the storage box based on the weight, or may determine the storage box based on the weight after determining the storage box based on the shape.

<Example of Determining Size after Weight>

First, the storage box determination unit 202 may determine a storage box based on the shape of the package after determining the storage box based on the weight of the package. That is, the storage box determination unit 202 determines the appearance of the storage box relevant to the storable weight based on the weight of the package. Then, the storage box determination unit 202 determines a size capable of storing the package from the storage box having the determined appearance based on the shape of the package. Specifically, in the example of FIG. 7, the storage box determination unit 202 determines the color of the storage box from blue, yellow, and red based on the weight of the package. Then, the storage box determination unit 202 determines the size of the storage box from large, medium, and small sizes based on the shape of the package. As a result, the storage box determination unit 202 determines the storage box.

For example, the storage box determination unit 202 calculates the total weight of packages based on the weight of each package. Then, the storage box determination unit 202 determines the package to be put in the same storage box based on the total weight and the storable weight in each storage box. As a result, the storage box determination unit 202 determines a storage box in which the package is stored from a plurality of storage boxes having different storable weights.

Here, an example in which the storage box determination unit 202 determines the storage box so that the number of storage boxes is minimized based on the total weight of packages of the same destination will be described. Furthermore, in the following example, for ease of explanation, it is assumed that a storage box for storing a package can be determined only by volume.

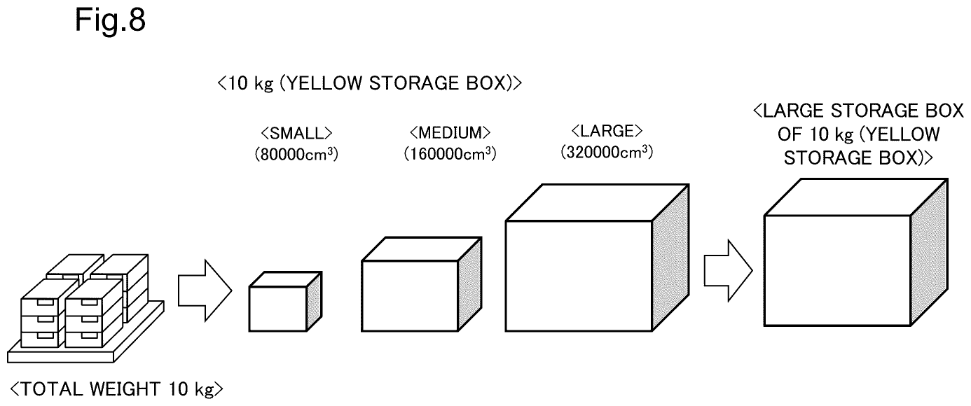

FIG. 8 is an explanatory diagram (part 1) illustrating an example in which the total weight of packages is 10 kg. For example, in a case where the total weight of packages is 10 kg, the storage box determination unit 202 determines one yellow storage box as the storage box so that the number of storage boxes is the smallest.

Then, the storage box determination unit 202 may determine a storage box having a size capable of storing the package from large, medium, and small storage boxes based on the shape of the package. Here, a case where the shape of each package is the same box shape, the volume of each package is 40,000 cm³ (cubic centimeters), and the number of packages is 8 will be described as an example. The large, medium, and small volumes of the box are as described in FIG. 7. Therefore, the storage box determination unit 202 determines a large storage box as a storage box that stores these packages.

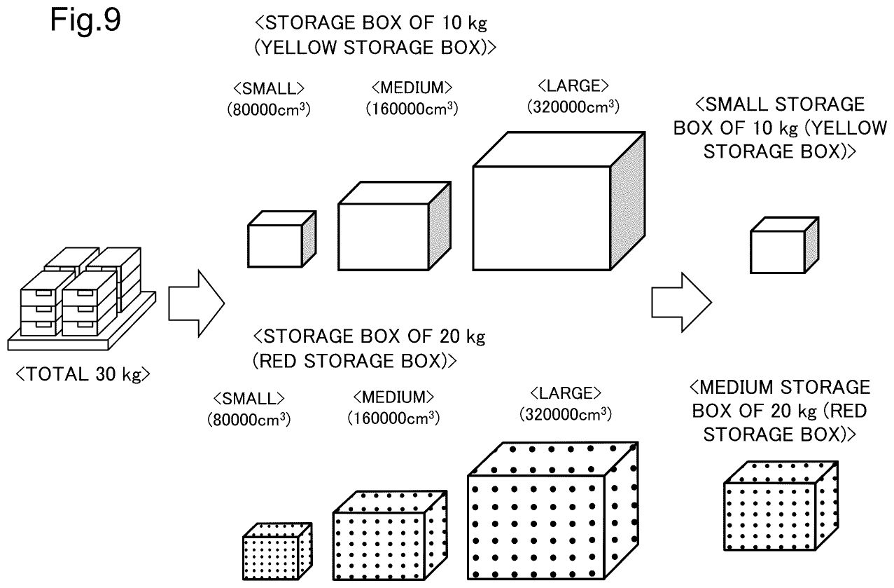

FIG. 9 is an explanatory diagram (part 1) illustrating an example in which the total weight of packages is 30 kg. For example, in a case where the total weight of packages is 30 kg, the storage box determination unit 202 determines one yellow storage box capable of storing 10 kg and one red storage box capable of storing 20 kg as the storage boxes so as to minimize the number of storage boxes. At this time, the storage box determination unit 202 determines the package to be put in each storage box. For example, if all the packages have the same shape and the same weight, the storage box determination unit 202 may determine the number of packages to be put in each storage box.

Then, the storage box determination unit 202 determines a storage box having a size capable of storing the package from large, medium, and small storage boxes based on the shape of the package. In FIG. 9, a case where the shape of each package is the same box shape, the volume of each package is 40,000 cm³, and the number of packages is 6 will be described as an example. The large, medium, and small volumes of the box are as described in FIG. 7. For example, it is assumed that two packages are stored in a yellow storage box capable of storing 10 kg. Assume that 4 packages are stored in a red storage box capable of storing 20 kg. Therefore, the storage box determination unit 202 determines a small storage box for the yellow storage box. Then, the storage box determination unit 202 determines a medium storage box for the red storage box.

<Example of Determining Weight after Size>

The storage box determination unit 202 may determine a storage box based on the weight of the package after determining the storage box based on the shape of the package. That is, the storage box determination unit 202 determines the size of the storage box based on the shape of the package. Then, the storage box determination unit 202 determines the appearance of the storage box having the determined size from the appearance relevant to the storable weight based on the weight of the package. Specifically, in the example of FIG. 7, the storage box determination unit 202 determines the size of the storage box from large, medium, and small sizes based on the shape of the package, and determines the color of the storage box from blue, yellow, and red based on the weight of the package. As a result, the storage box determination unit 202 determines the storage box.

Here, an example in which the storage box determination unit 202 determines the storage box so that the number of storage boxes is minimized based on the shape of each package will be described. Furthermore, in the following example, for ease of explanation, it is assumed that a storage box for storing a package can be determined only by volume.

Specifically, for example, the storage box determination unit 202 determines a storage box capable of storing the package from the plurality of storage boxes based on the shape of the package. Here, for example, the shape of the package will be described using the volume of the package.

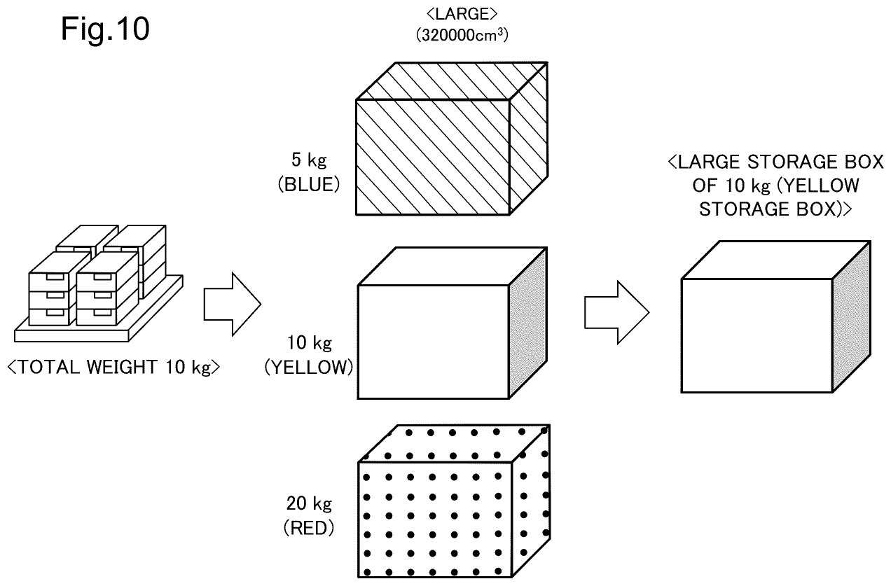

FIG. 10 is an explanatory diagram illustrating an example in which the total volume of packages is 320,000 cm³. The storage box determination unit 202 may determine a storage box having a size capable of storing the package from large, medium, and small storage boxes based on the shape of the package. A case where the shape of each package is the same box shape, the volume of each package is 40,000 cm³, and the number of packages is 8 will be described as an example. The total volume of the package is 320,000 cm³. The large, medium, and small volumes of the box are as described in FIG. 7. Therefore, the storage box determination unit 202 determines a large storage box as a storage box that stores these packages.

Next, for example, in a case where the total weight of packages is 10 kg, the storage box determination unit 202 determines one large yellow storage box as the storage box.

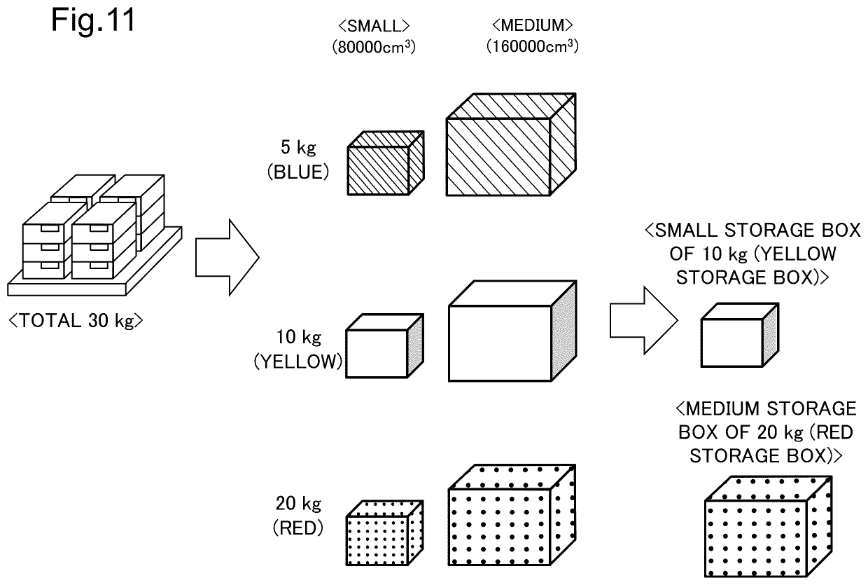

FIG. 11 is an explanatory diagram illustrating an example in which the total volume of packages is 240,000 cm³. The storage box determination unit 202 determines a storage box having a size capable of storing the package from large, medium, and small storage boxes based on the shape of the package. In FIG. 11, a case where the shape of each package is the same box shape, the volume of each package is 40,000 cm³, and the number of packages is 6 will be described as an example. The large, medium, and small volumes of the box are as described in FIG. 7. The weight of each package is assumed to be 5 kg.

For example, since the total volume of packages is 240,000 cm³, the storage box determination unit 202 determines one large storage box if the number of storage boxes is minimized. However, since the weight that can be stored in the large storage box is 20 kg, all the six packages cannot be stored in the large storage box. Therefore, for example, the storage box determination unit 202 determines one small storage box and one medium storage box so that, for example, two packages are put in the small storage box and four packages are put in the medium storage box.

Next, for the small storage box, the storage box determination unit 202 determines the yellow storage box since the total weight in the case of storing two packages out of the six packages is 10 kg. Then, for the medium storage box, the storage box determination unit 202 determines a red storage box since the total weight in the case of storing four packages out of the six packages is 20 kg.

This is the end of the detailed example.

In the examples of FIGS. 9 and 11, the storage box determination unit 202 determines the storage box so that the number of storage boxes is reduced. For example, in a case where the storage box determination unit 202 determines the storage boxes so that the weights of the packages stored in the storage boxes are equal based on the shapes and weights of the sorted packages, three small yellow storage boxes may be determined so that each storage box becomes 10 kg by putting two packages in each storage box. As a result, since the weight of the storage box is uniform, the work efficiency can be improved.

### <Example of Using Cushioning Material>

When the package is stored in the storage box, it may be necessary to finely adjust the weight and size of the package using a cushioning material or the like. In such a case, the storage box determination unit 202 may determine the type of the cushioning material and the amount of the cushioning material to be stored in the storage box based on the cushioning material DB 2003.

For example, after the package is stored in the storage box, the cushioning material may be put in the storage box so that the storage box has a storable weight. A case where the total weight of packages is 9.5 kg and the total volume of packages is 60,000 cm³ will be described as an example. For example, in a case where a yellow small box capable of storing 10 kg is used, 0.5 kg is required until the weight becomes a storable weight. In such a case, the storage box determination unit 202 determines the type of the cushioning material and the amount of the cushioning material such that a weight of 0.5 kg can be added in a volume of 20,000 cm³ or less based on the cushioning material DB 2003. As a result, the weight of the storage box after storing the package at the time of delivery can be made more uniform.

Alternatively, after the package is stored in the storage box, the cushioning material may be put in the storage box so that the storage box is filled to a certain amount. An example in which the cushioning material is placed in the storage box so as not to form a gap in the storage box will be described. Similarly to the above example, a case where the total weight of packages is 9.5 kg and the total volume of packages is 60,000 cm³ will be described as an example. For example, in a case where a yellow small box capable of storing 10 kg is used, 20,000 cm³ is required before the gap is filled. In such a case, the storage box determination unit 202 determines the type of the cushioning material and the amount of the cushioning material capable of filling the gap of 20,000 cm³ with the weight of 0.5 kg or less based on the cushioning material DB 2003.

The storage box determination unit 202 determines the storage box so that the weight of the cushioning material does not become equal to or more than the weight of the package. For example, in a case where the total weight of packages is 7 kg and a storage box capable of storing 20 kg is used, 13 kg of the cushioning material is required in order to set the weight of the storage box after storing the package to 20 kg. For example, in a case where the total weight of packages is 7 kg and a storage box capable of storing 10 kg is used, 3 kg of the cushioning material is required in order to set the weight of the storage box after storing the package to 10 kg. In such a case, the storage box determination unit 202 determines a storage box capable of storing 10 kg so that the weight of the cushioning material does not become equal to or more than the weight of the package.

That is, the output control unit 203 outputs an instruction for storing the packages in the determined storage box. Specifically, for example, the output control unit 203 outputs an instruction to store the package in the storage box having the determined appearance and size. The instruction here may include designation of a package to be stored for each determined storage box. For example, the instruction may include information such as the number of packages.

In a case where the operator stores the package in the storage box, the output control unit 203 may display the instruction on the display device 24. The display device 24 may be provided in a terminal device that can be confirmed by an operator. For example, the type of the terminal device may be a personal computer (PC), a tablet-type device, a smartphone, and the like, and is not particularly limited.

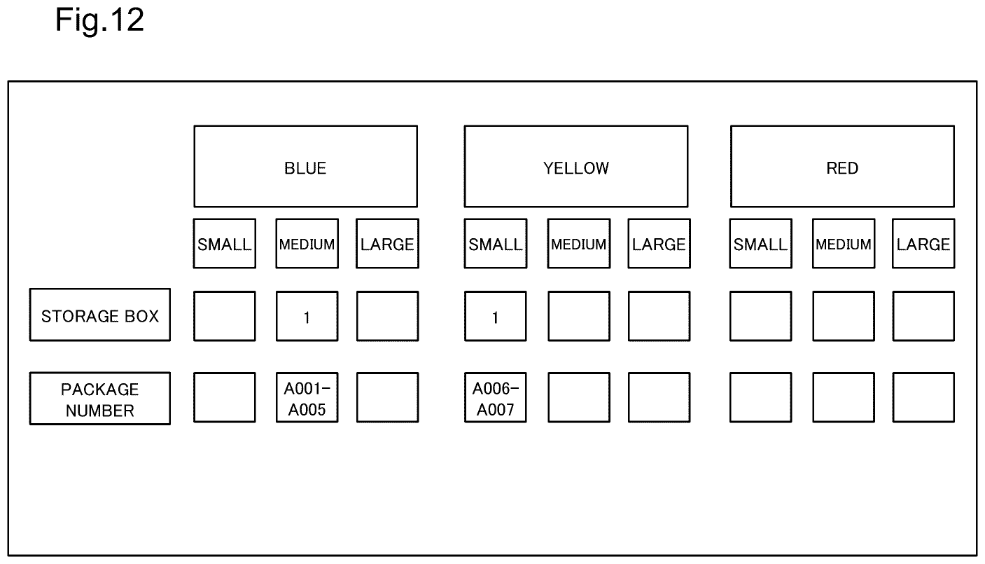

FIG. 12 is an explanatory diagram illustrating an example of a screen to be displayed on the display device 24. In FIG. 12, the output control unit 203 display a screen including information indicating the determined storage box and package identification information to be stored in the storage box on the display device 24. In FIG. 12, according to the screen, it can be confirmed that the packages with the package numbers A001 to A005 are stored in the medium blue storage box. In FIG. 12, according to the screen, it can be confirmed that the packages of the package numbers A006 to A007 are stored in the medium yellow storage box.

In a case where a transport device stores the package in the storage box, the output control unit 203 notifies a transport device of an instruction. The transport device may be a transport robot as illustrated in FIG. 3. The output control unit 203 may control the transport device so as to store the package in the determined storage box.

In a case where the code is attached, the reading device 23 may identify the weight of the package by reading the code, for example. In a case where the operator stores the package in the storage box, the reading device 23 may be provided in a terminal device used by the operator. In a case where the transport robot stores a package in the storage box, the reading device 23 may be provided in the transport robot.

In the above example, an example in which the appearance is different for each storage box has been described in advance. For example, storage boxes having a plurality of sizes may be prepared in advance, and the appearance may be changed later according to the weight of the packages stored in the storage box. For example, it is conceivable to change the appearance with a sticker or the like. The plain white box may be later provided with a colored sticker or a patterned sticker. In such a case, the output control unit 203 may output an instruction to attach a sticker to the storage box so as to have the determined appearance. Alternatively, the output control unit 203 may issue a sticker attached to the storage box so as to have the determined appearance. Then, the operator or the transport robot may attach the sticker to the storage box according to the instruction.

For example, in a case where a sticker including a two-dimensional code is issued, the output control unit 203 may store information included in the two-dimensional code. The information included in the two-dimensional code is, for example, a destination, a weight, and the like. This information may further include package identification information and the like.

As described in the first example embodiment, a means for delivering the packages stored in the storage box is not particularly limited, and examples thereof include a vehicle, a drone, a ship, and an airplane.

For example, in a case where a vehicle delivers, the combination determination unit 204 may determine a combination of loading storage boxes to each vehicle so that the storage boxes having the same weight are loaded on vehicles of the same vehicle rating.

In a case where the drone delivers, the drone may deliver the storage box in which the operator or the transport robot stores the packages as it is. For example, the drone may specify the weight of the storage box from the appearance of the storage box and determine whether the weight is a deliverable weight. Then, the drone may convey the storage box determined to be deliverable. In a case where the two-dimensional code is used as the appearance that can identify the weight, the drone may include the reading device 23, and the reading device 23 may specify the weight of the storage box by reading the two-dimensional code of the storage box. As described above, since the storage box has an appearance relevant to the storable weight, the drone can easily grasp the weight of the storage box in a case where the drone delivers.

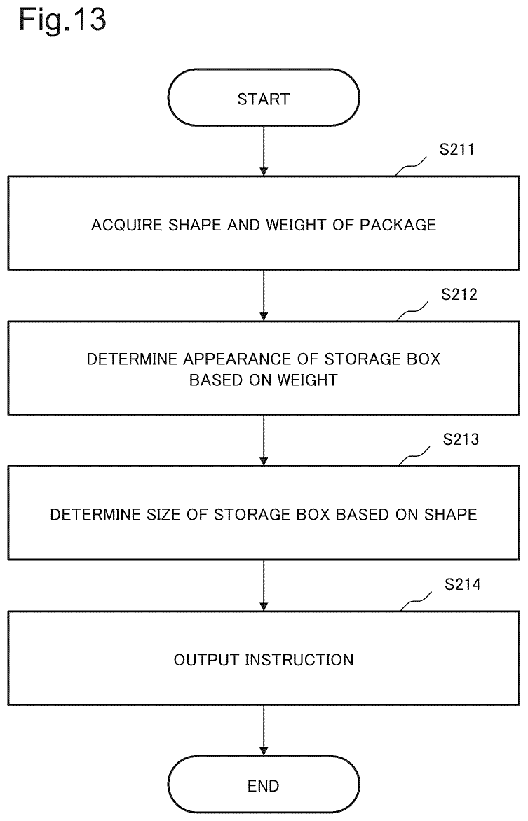

FIG. 13 is a flowchart illustrating an operation example of the delivery assistance system 20 according to the second example embodiment. For example, the acquisition unit 201 acquires the shape and weight of each package (step S211). Next, the storage box determination unit 202 determines the appearance of the storage box based on the weights of the packages of the same destination (step S212). In the example of FIG. 7, the appearance is a color, and the color will be described as an example. In step S212, the storage box determination unit 202 calculates the total weight of packages of the same destination. Then, the storage box determination unit 202 determines the color of the storage box based on the total weight. Here, the storage box determination unit 202 determines the package to be stored in each storage box.

Specifically, for example, the storage box determination unit 202 determines the color of the storage box so that the number of storage boxes is the smallest. Alternatively, specifically, for example, the storage box determination unit 202 may determine the color of the storage box so that the weight of the storage box is uniform.

Next, the storage box determination unit 202 determines the size of the storage box of the determined color based on the shape of the package (step S213). For example, the storage box determination unit 202 calculates the total volume of packages stored in the storage box of the determined color. Then, for example, the storage box determination unit 202 determines the size of the storage box that satisfies the total volume.

Then, the output control unit 203 outputs an instruction to store the package in the determined storage box (step S214). Then, the delivery assistance system 20 ends the processing.

In FIG. 13, an example has been described in which the storage box determination unit 202 determines the color of the storage box based on the weight of the package in step S212, and then determines the size of the storage box based on the shape of the package in step S213. However, as described above, the order of step S212 and step S213 is not particularly limited.

As described above, in the second example embodiment, the delivery assistance system 20 determines the storage box in which the package is stored based on the shapes and weights of packages with the same destination among the plurality of packages, and outputs an instruction to store the package in the determined storage box. For example, since the storage box is determined in advance, the packing form of the package at the time of delivery is standardized by putting each package in the storage box. Therefore, it is possible to more efficiently mount the package on the means for delivering the package. For example, even in the case of transshipment or the like, if the packing form of the package at the time of delivery is standardized, the package can be more efficiently loaded. For example, since the packing form is standardized, it is possible to facilitate loading and unloading in the case of jointly delivering packages. Furthermore, since the packing form is standardized, it is possible to improve a matching rate in a case where packages are delivered together. As a result, it is possible to improve the loading rate of the means for delivering packages. Since the weight, size, and the like of the package put in the storage box are not measured again at a different base or the like, it is possible to save time and effort for these measurements.

In a case where packages are delivered together, a lot of transshipment work occurs. By standardizing the packing forms, it is possible to improve the matching rate in a case where the packages are delivered together. Therefore, the transshipment can be performed more efficiently.

Here, the plurality of packages may be sorted for each destination. As a result, the packages can be more efficiently stored in the storage box.

The delivery assistance system 20 determines a storage box capable of storing packages from a plurality of storage boxes having different sizes based on the shape of the package.

The storable weight of the plurality of storage boxes is determined, and the delivery assistance system 20 determines a storage box capable of storing the packages from the plurality of storage boxes based on the weight of the package. For example, the plurality of storage boxes have an appearance capable of identifying a storable weight. The appearance is at least one of a color, a pattern, a mark, and a code relevant to a storable weight. The code is letters, numbers, a combination of letters and numbers. The code may be represented by a one-dimensional code or a two-dimensional code. As a result, the operator can visually determine the weight of the storage box at the time of loading work. The transport robot can determine the weight of the storage box by using an image or the like captured from the storage box. For example, in the case of a code, the reading device 23 can identify the weight of the storage box by reading the code. As described above, at the time of delivery using a drone or the like, the drone can easily grasp the weight of the storage box. Therefore, it is possible to improve the efficiency of the loading operation and the efficiency of the delivery operation. It is easy to determine whether the weight of a combination of a plurality of storage boxes is excessive by image analysis or the like. Furthermore, when the storage box is transferred at a different base, the operator or the transport robot at the base can determine the weight of the storage box. Therefore, the efficiency of the transshipment can be improved.

The delivery assistance system 20 determines the appearance of the storage box capable of storing the package from the appearance relevant to the storable weight based on the weight of the package, and determines the size capable of storing the package from the storage box having the determined appearance based on the shape of the package. Alternatively, the delivery assistance system 20 determines the size of the storage box based on the shape of the package, and determines the appearance of the storage box having the determined size from the appearance relevant to the storable weight based on the weight of the package.

The delivery assistance system 20 outputs an instruction to store the package in the storage box having the determined size and the determined appearance. The delivery assistance system 20 displays the instruction on the display device 24. The delivery assistance system 20 may notify the transport device of the instruction or may control the transport device according to the instruction.

The delivery assistance system 20 outputs an instruction to set the appearance of the storage box having the determined size to be the determined appearance. For example, the operator or the transport robot can attach a sticker or the like to the storage box so as to have the determined appearance according to the instruction.

The description of each example embodiment is ended. The example embodiments may be used in combination. In each example embodiment, the delivery assistance system 20 may have a configuration including each functional unit and a part of information.

Each example embodiment is not limited to the example described above, and various modifications can be made. The configuration of the delivery assistance system 20 in each example embodiment is not particularly limited. For example, the delivery assistance system 20 may be achieved by one device such as one terminal device and one server. Alternatively, the delivery assistance system 20 may be achieved by different devices for each function or data. For example, the delivery assistance system 20 may include a plurality of servers.

In each example embodiment, each piece of information may include a part of the above-described information. Each piece of information may include information other than the above-described information. Each piece of information may be divided into a plurality of tables or a plurality of pieces of information in more detail. As described above, a method of implementing each piece of information is not particularly limited.

Each screen displayed on the display device 24 is an example, and is not particularly limited. In each screen, a button, a list, a check box, an information display field, an input field, and the like (not illustrated) may be added. The background color of the screen and the like may be changed.

For example, in each example embodiment, the processing of generating information or the like of a screen to be displayed on the display device 24 may be performed by the output control unit 203 of the delivery assistance system 20. For example, this process may be performed by the display device 24.

### (Exemplary Hardware Configuration of Computer)

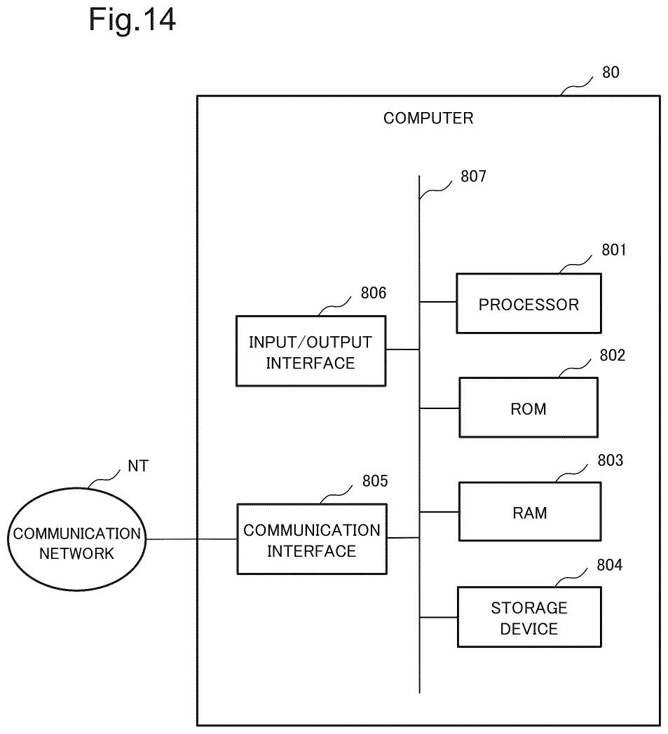

Next, an exemplary hardware configuration in a case where each device such as the delivery assistance system and the terminal device described in each example embodiment is achieved by a computer will be described. FIG. 14 is an explanatory diagram illustrating an exemplary hardware configuration of a computer. For example, some or all of the devices can be achieved by using an arbitrary combination of a computer 80 and a program as illustrated in FIG. 14 for example.

The computer 80 includes, for example, a processor 801, a read only memory (ROM) 802, a random access memory (RAM) 803, and a storage device 804. The computer 80 includes a communication interface 805 and an input/output interface 806. The components are connected via, for example, a bus 807. The number of components is not particularly limited, and each component is one or more.

The processor 801 controls the entire computer 80. Examples of the processor 801 include a central processing unit (CPU), a digital signal processor (DSP), and a graphics processing unit (GPU). The computer 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

The processor 801 loads a program stored in the storage device 804, the ROM 802, or the like. Then, the processor 801 executes each process coded in the program. The processor 801 may download various programs via the communication network NT. The processor 801 functions as a part or all of the computer 80. Then, the processor 801 may execute processing or instructions in the illustrated flowchart based on the program.

The communication interface 805 is connected to a communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. Then, the communication interface 805 controls input and output of data from an external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that outputs voice. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 14. The computer 80 may have components other than those illustrated in FIG. 14. For example, the computer 80 may include a drive device or the like. Then, the processor 801 may read a program or data stored in a recording medium attached to a drive device or the like into the RAM 803. Examples of the non-transitory tangible recording medium include an optical disk, a flexible disk, a magnetic optical disk, and a universal serial bus (USB) memory. As described above, for example, the computer 80 may include an input device such as a keyboard and a mouse. The computer 80 may have an output device such as a display. The computer 80 may include an input device, an output device, and an input/output device.

The computer 80 may include various sensors (not illustrated). The type of the sensor is not particularly limited. Examples of the sensor include an acceleration sensor, a gyro sensor, a magnetic sensor, a global positioning system (GPS), and a sensor. Examples of the sensor include a fingerprint sensor, LiDAR (Light, Detection and Ranging), a proximity sensor, and an ambient light sensor.

The computer 80 may include a display device 24. The computer 80 may have a weight sensor 21. The computer 80 may include an imaging device 22. The computer 80 may include a reading device 23.

This is the end of the description of the hardware configuration of each device. There are various modifications of the method of achieving each device. For example, each device may be achieved by an arbitrary combination of a computer and a program different for each component. A plurality of components included in each device may be achieved by any combination of one computer and a program.

A part or all of each component of each device may be achieved by an application specific circuit. A part or all of each component of each device may be achieved by a general-purpose circuit including a processor such as a field programmable gate array (FPGA). A part or all of each component of each device may be achieved by a combination of an application specific circuit, a general-purpose circuit, or the like. These circuits may be a single integrated circuit. Alternatively, these circuits may be divided into a plurality of integrated circuits. The plurality of integrated circuits may be configured by being connected via a bus or the like.

In a case where a part or all of each component of each device is achieved by a plurality of computers, circuits, and the like, the plurality of computers, circuits, and the like may be arranged in a centralized manner or in a distributed manner.

The delivery assistance method described in each example embodiment is achieved by the delivery assistance system. For example, the delivery assistance method is achieved by a computer such as a server or a terminal device executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. The program may be distributed via the communication network NT.

Each component of the delivery assistance system in each example embodiment described above may be achieved by hardware such as the computer. Alternatively, each component may be achieved by a computer or firmware based on program control.

Although the present disclosure has been particularly illustrated and described with reference to the present example embodiment, the present disclosure is not limited to the above example embodiment. The configuration and details of each present disclosure may include example embodiments to which various changes that can be grasped by those skilled in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

A part or all of the above example embodiments can also be described as the following Supplementary Notes. However, a part or all of the above example embodiments are not limited to the following.

### (Supplementary Note 1)

A delivery assistance system including:
an acquisition means for acquiring a shape and a weight of each of a plurality of packages;
a storage box determination means for determining a storage box having a predetermined size and storing packages based on shapes and weights of the packages with a same destination among the plurality of packages; and
an output control means for outputting an instruction to store the packages in the determined storage box.

### (Supplementary Note 2)

The delivery assistance system according to Supplementary Note 1, in which
a plurality of storage boxes have different sizes, and
the storage box determination means determines a storage box in which the package is stored from the plurality of storage boxes based on a shape of the package.

### (Supplementary Note 3)

The delivery assistance system according to Supplementary Note 1 or 2, in which
a storable weight of a plurality of storage boxes is determined, and
the storage box determination means determines a storage box that stores the package from the plurality of storage boxes based on a weight of the package.

### (Supplementary Note 4)

The delivery assistance system according to Supplementary Note 3, in which
the plurality of storage boxes have an appearance capable of identifying the storable weight.

### (Supplementary Note 5)

The delivery assistance system according to Supplementary Note 4, in which
the appearance is at least one of a color, a pattern, a mark, and a code relevant to the storable weight.

### (Supplementary Note 6)

The delivery assistance system according to Supplementary Note 5, in which
the storage box determination means determines an appearance relevant to the storable weight based on a weight of the package, and determines a size of a storage box for storing the package based on a shape of the package, and
the output control means outputs an instruction to store the package in a storage box having the determined appearance and the determined size.

### (Supplementary Note 7)

The delivery assistance system according to Supplementary Note 5, in which
the storage box determination means determines a size of a storage box for storing the package based on a shape of the package, and determines an appearance relevant to the storable weight based on a weight of the package, and
the output control means outputs an instruction to store the package in a storage box having the determined appearance and the determined size.

### (Supplementary Note 8)

The delivery assistance system according to Supplementary Note 6 or 7, in which
the output control means outputs an instruction to store the package in a storage box having the determined size and having the determined appearance.

### (Supplementary Note 9)

The delivery assistance system according to Supplementary Note 6 or 7, in which
the output control means outputs an instruction to set an appearance of a storage box having the determined size to the determined appearance.

### (Supplementary Note 10)

The delivery assistance system according to any one of Supplementary Notes 1 to 7, in which
the output control means displays the instruction on a display device.

### (Supplementary Note 11)

The delivery assistance system according to any one of Supplementary Notes 1 to 7, in which
the output control means notifies a transport device of the instruction.

### (Supplementary Note 12)

A delivery assistance method including:
acquiring a shape and a weight of each of a plurality of packages;
determining a storage box having a predetermined size and storing the package based on shapes and weights of packages with a same destination among the plurality of packages; and
outputting an instruction to store the package in the determined storage box.

### (Supplementary Note 13)

A non-transitory computer-readable recording medium having stored therein a program causing a computer to execute:
acquiring a shape and a weight of each of a plurality of packages;
determining a storage box having a predetermined size and storing the package based on shapes and weights of packages with a same destination among the plurality of packages; and
outputting an instruction to store the package in the determined storage box.

### (Supplementary Note 14)

A program causing a computer to execute:
acquiring a shape and a weight of each of a plurality of packages;
determining a storage box having a predetermined size and storing the package based on shapes and weights of packages with a same destination among the plurality of packages; and
outputting an instruction to store the package in the determined storage box.

### REFERENCE SIGNS LIST

10, 20 delivery assistance system
21 weight sensor
22 imaging device
23 reading device
24 display device
80 computer
101, 201 acquisition unit
102, 202 storage box determination unit
103, 203 output control unit
204 combination determination unit
801 processor
802 ROM
803 RAM
804 storage device
805 communication interface
806 input/output interface
807 bus
A001, A002, A003, A004, A005, A006, A007 package number
2001 package DB
2002 storage box DB
2003 cushioning material DB
NT communication network

What is claimed is:

1. A delivery assistance system comprising:
at least one memory storing instructions; and
at least one processor configured to execute the instructions to:
acquire a shape and a weight of each of a plurality of packages;
determine a storage box having a predetermined size and storing packages based on shapes and weights of the packages with a same destination among the plurality of packages; and
output an instruction to store the packages in the determined storage box.

2. The delivery assistance system according to claim 1, wherein
a plurality of storage boxes have different sizes, and wherein the at least one processor is further configured to execute the instructions to:
determine a storage box in which the package is stored from the plurality of storage boxes based on a shape of the package.

3. The delivery assistance system according to claim 1, wherein
a storable weight of a plurality of storage boxes is determined, and wherein the at least one processor is further configured to execute the instructions to:
determine a storage box that stores the package from the plurality of storage boxes based on a weight of the package.

4. The delivery assistance system according to claim 3, wherein
the plurality of storage boxes have an appearance capable of identifying the storable weight.

5. The delivery assistance system according to claim 4, wherein
the appearance is at least one of a color, a pattern, a mark, and a code relevant to the storable weight.

6. The delivery assistance system according to claim 5, wherein the at least one processor is further configured to execute the instructions to:
determine an appearance relevant to the storable weight based on a weight of the package, and determines a size of a storage box for storing the package based on a shape of the package, and
output an instruction to store the package in a storage box having the determined appearance and the determined size.

7. The delivery assistance system according to claim 5, wherein the at least one processor is further configured to execute the instructions to:
determine a size of a storage box for storing the package based on a shape of the package, and determines an appearance relevant to the storable weight based on a weight of the package, and
output an instruction to store the package in a storage box having the determined appearance and the determined size.

8. The delivery assistance system according to claim 6, wherein the at least one processor is further configured to execute the instructions to:
output an instruction to store the package in a storage box having the determined size and having the determined appearance.

9. The delivery assistance system according to claim 6, wherein the at least one processor is further configured to execute the instructions to:
output an instruction to set an appearance of a storage box having the determined size to the determined appearance.

10. The delivery assistance system according to claim 1, wherein the at least one processor is further configured to execute the instructions to:
display the instruction on a display device.

11. The delivery assistance system according to claim 1, wherein the at least one processor is further configured to execute the instructions to:
notify a transport device of the instruction.

12. A delivery assistance method comprising:
acquiring a shape and a weight of each of a plurality of packages;
determining a storage box having a predetermined size and storing the package based on shapes and weights of packages with a same destination among the plurality of packages; and
outputting an instruction to store the package in the determined storage box.

13. A non-transitory computer-readable recording medium having stored therein a program causing a computer to execute:
acquiring a shape and a weight of each of a plurality of packages;
determining a storage box having a predetermined size and storing the package based on shapes and weights of packages with a same destination among the plurality of packages; and
outputting an instruction to store the package in the determined storage box.
